(19) United States
(12) Patent Application Publication
(10) Pub. No.: US 2014/0027604 A1
(43) Pub. Date: Jan. 30, 2014

(54) MOUNTING APPARATUS FOR FAN

(71) Applicant: HAI-TAO GONG, Shenzhen City (CN)

(72) Inventor: HAI-TAO GONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/570,699

(22) Filed: Aug. 9, 2012

(30) Foreign Application Priority Data
Jul. 24, 2012 (CN) 2012102572468

(51) Int. Cl. F16M 9/00; F16M 13/00

(52) U.S. Cl. 248/672; 248/674

(57) ABSTRACT

A mounting apparatus includes a bracket and a securing member. The bracket includes two securing plates substantially parallel to each other. Each of the two securing plates defines a securing hole. The securing member includes two securing boards and a handgrip. The two securing boards are substantially parallel to each other and configured to be secured to a fan. Each of the two securing boards includes a resilient portion. A locking tab is located on the resilient portion of each of the two securing boards and engaged in the securing hole of each of the two securing plates. The handgrip is integrated with the resilient portions of the two securing boards. The resilient portions are resiliently deformable to disengage the locking tabs from the securing holes when pulled by the handgrip.

### BACKGROUND

1. Technical Field

The present disclosure relates to mounting apparatuses, and more particular to a mounting apparatus for a fan.

2. Description of Related Art

In working computer systems, a large amount of heat is generated from the electric elements of the computer system. If the heat is not dissipated efficiently, the electric elements may be damaged. A fan is a conventional means to dissipate heat from the computer system. A rack is provided for receiving a fan. The rack is attached to the computer system by a relatively complicated process. It is well known within the art, that assembly and disassembly of the fans can be inconvenient.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a mounting apparatus of a fan in accordance with one embodiment.

FIG. 2 is an exploded, isometric view of a securing member and the fan of FIG. 1.

FIG. 3 is an assembled view of the mounting apparatus and the fan of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

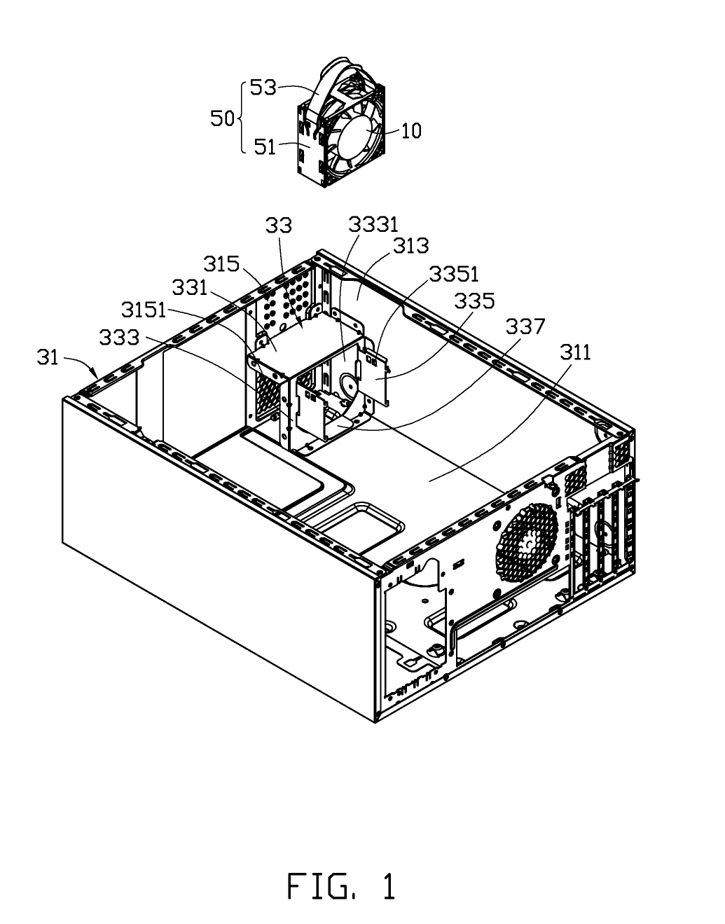

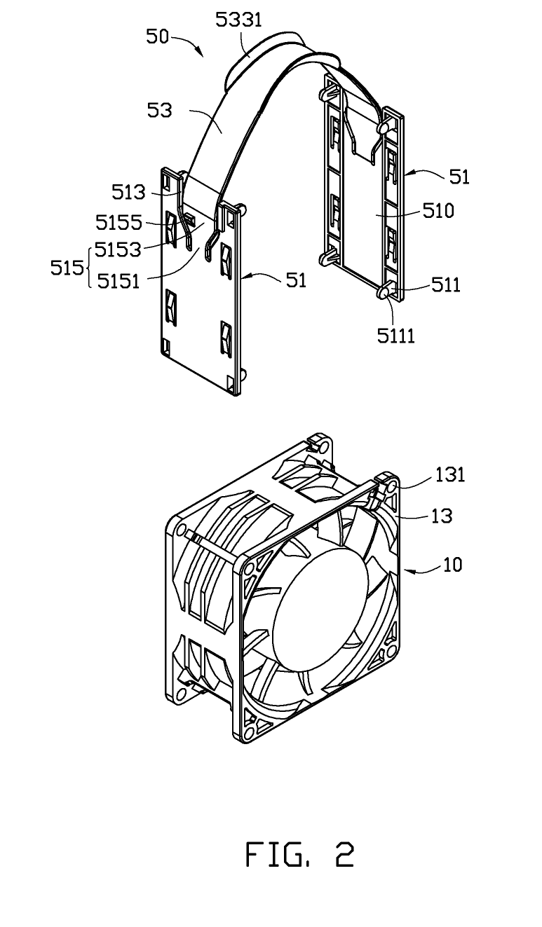

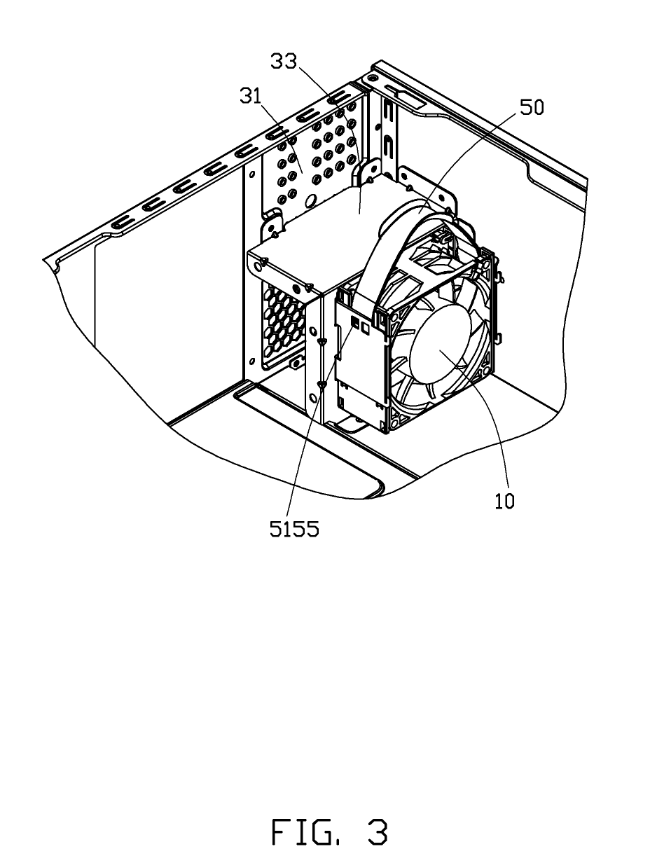

Referring to FIGS. 1-3, a mounting apparatus in accordance with an embodiment is shown. The mounting apparatus includes a bracket 33 and a securing member 50. The securing member 50 is configured to secure a fan 10 to the bracket 33. The fan 10 includes two sidewalls 13 that are substantially parallel to each other. Each of the two sidewalls 13 defines four mounting holes 131 in four corners of each of the two sidewalls 13.

The bracket 33 includes a base plate 331 and a side plate 333 extending substantially perpendicularly from the base plate 331. The side plate 333 defines a through opening 3331. Two securing plates 335 and a support plate 337 are located on the side plate 333. Each of the two securing plates 335 defines a securing hole 3351 adjacent a top edge of each of the two securing plates 335. The two securing plates 335 extend from two opposite edges of the through opening 3331, and the support plate 337 extends from a bottom edge of the through opening 3331. The two securing plates 335 are substantially parallel to each other and perpendicular to the support plate 337.

The securing member 50 includes two securing boards 51 and a handgrip 53, integral with the two securing boards 51. Each of the two securing boards 51 includes a board body 510, four posts 511, and a resilient portion 515. The four posts 511 are located on the board body 510, and a protrusion 5111 extends from each of the four posts 511. Each of the two securing boards 51 defines two slits 513 between the board body 510 and each of two opposite edges of the resilient portion 515. The resilient portion 515 includes a narrow portion 5151 and a wide portion 5153. The narrow portion 5151 extends from the board body 510, and the wide portion 5153 extends from the narrow portion 5151. A locking tab 5155 protrudes from the wide portion 5153 of each of the two securing boards 51. The handgrip 53 extends from the wide portions 5153 of the two securing boards 51. Two flanges 5331 extend from two opposite edges of the handgrip 53.

In assembly, the protrusions 5111 of the two securing boards 51 are locked into the mounting holes 131 of the two sidewalls 13, and the securing member 50 is secured to the fan 10. The assembly of the securing member 50 and the fan 10 is then inserted in between the two securing plates 335. The resilient portions 515 are resiliently deformed inward when the locking tabs 5155 are pressed inward by the two securing plates 335. When the locking tabs 5155 are aligned with the securing holes 3351 of the two securing plates 335, the resilient portions 515 rebound, and the locking tabs 5155 are engaged in the securing holes 3351. Thus, the fan 10 is secured to the bracket 33.

In disassembly, the handgrip 53 is pulled up to resiliently deform the resilient portions 515 inward. When the locking tabs 5155 are disengaged from the securing holes 3351, the securing member 50 and the fan 10 can be pulled out of the bracket 33.

The mounting apparatus of an embodiment further includes a chassis 31. The chassis 31 includes a bottom panel 311, a first side panel 313, and a second side panel 315. The bottom panel 311 is connected to both the first side panel 313 and the second side panel 315. The first side panel 313 and the second side panel 315 are substantially parallel to each other and perpendicular to the bottom panel 311. The second side panel 315 defines a plurality of ventilation holes 3151.

The bracket 33 is fixed in the chassis 31. The base plate 331 is secured to both the first side panel 313 and the second side panel 315. The side plate 333 is secured to the bottom panel 311 and the first side panel 313. The through opening 3331 faces the plurality of ventilation holes 3151. The base plate 331 is substantially parallel to the bottom panel 311 and perpendicular to both the first side panel 313 and the second side panel 315. The side plate 333 is parallel to the second side panel 315 and substantially perpendicular to the bottom panel 311 and the first side panel 313. The two securing plates 335 are substantially parallel to the first side panel 313 and perpendicular to the bottom panel 311 and the second side panel 315. The support plate 337 is substantially parallel to the bottom panel 311 and perpendicular to both the first side panel 313 and the second side panel 315.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

1. A mounting apparatus comprising:
a bracket comprising two securing plates substantially parallel to each other, each of the two securing plates defining a securing hole; and
a securing member comprising two securing boards and a handgrip, the two securing boards are substantially parallel to each other and configured to be secured to a fan, each of the two securing boards comprising a resilient portion, a locking tab located on the resilient portion of each of the two securing boards and engaged in the securing hole of each of the two securing plates, and the handgrip integrated with the resilient portions of the two securing boards;
wherein the resilient portions are resiliently deformable to disengage the locking tabs from the securing holes when pulled by the handgrip.

2. The mounting apparatus of claim 1, wherein each of the two securing boards comprises a board body, the resilient portion of each of the two securing boards extends from the board body, and each of the two securing boards defines two slits between the board body and the resilient portion.

3. The mounting apparatus of claim 2, wherein the resilient portion of each of the two securing boards comprises a narrow portion and a wide portion extending from the narrow portion of each of the two securing boards, the narrow portion extending from the board body, and the handgrip is connected to the wide portion of each of the two securing boards.

4. The mounting apparatus of claim 1, wherein two flanges extend from opposite edges of the handgrip.

5. The mounting apparatus of claim 1, wherein the bracket further comprises a support plate that is substantially perpendicular to the two securing boards, and the support plate is configured to support the fan.

6. The mounting apparatus of claim 5, wherein the bracket further comprises a base plate and a side plate, the side plate extends substantially perpendicularly from the base plate, the two securing plates and the support plate are located on the side plate, and the two securing plates are substantially perpendicular to the base plate and the side plate, and the support plate is substantially parallel to the base plate.

7. The mounting apparatus of claim 6, further comprising a chassis, wherein the chassis comprises a bottom panel, a first side panel, and a second side panel; the first side panel and the second side panel are substantially parallel to each other and perpendicular to the bottom panel; the base plate is secured to both the first side panel and the second side panel; the side plate is secured to the bottom panel; and the base plate is substantially parallel to the bottom panel and perpendicular to both the first side panel and the second side panel.

8. The mounting apparatus of claim 7, wherein the side plate defines a through opening, and the second side panel defines a plurality of ventilation holes, facing the through opening.

9. Amounting apparatus comprising:
a chassis comprising a bottom panel and a side panel, the side panel substantially perpendicular located on the bottom panel;
a bracket secured to the bottom panel and the side panel, the bracket comprising two securing plates, the two securing plates are substantially perpendicular to the bottom panel and the side panel, each of the two securing plates defining a securing hole; and
a securing member comprising two securing boards and a handgrip, the two securing boards are configured to be secured to a fan, each of the two securing boards comprising a resilient portion, a locking tab located on the resilient portion of each of the two securing boards and engaged in the securing hole of each of the two securing plates, and the handgrip integrated with the resilient portions of the two securing boards;
wherein the resilient portions are resiliently deformable to disengage the locking tabs from the securing holes when pulled by the handgrip.

10. The mounting apparatus of claim 9, wherein the two securing plates are substantially parallel to each other, and the two securing boards are substantially parallel to each other.

11. The mounting apparatus of claim 9, wherein each of the two securing boards comprises a board body, the resilient portion of each of the two securing boards extends from the board body, and each of the two securing boards defines two slits between the board body and the resilient portion.

12. The mounting apparatus of claim 10, wherein the resilient portion of each of the two securing boards comprises a narrow portion and a wide portion extending from the narrow portion, the narrow portion extending from the board body of each of the two securing boards, and the handgrip is connected to the wide portion of each of the two securing boards.

13. The mounting apparatus of claim 12, wherein two flanges extend from opposite edges of the handgrip.

14. The mounting apparatus of claim 9, wherein the bracket further comprises a support plate that is substantially perpendicular to the two securing boards, and the support plate is configured to support the fan.

15. The mounting apparatus of claim 14, wherein the bracket further comprises a base plate and a side plate, the side plate extends substantially perpendicularly from the base plate, the two securing plates and the support plate are located on the side plate, and the two securing plates are substantially perpendicular to the base plate and the side plate, and the support plate is substantially parallel to the base plate.

16. The mounting apparatus of claim 15, wherein the base plate is secured to the side panel; the side plate is secured to the bottom panel; and the base plate is substantially parallel to the bottom panel and perpendicular to the side panel.

17. The mounting apparatus of claim 3, wherein each of the two securing boards further comprises four posts located on the board body, a protrusion extends from each of the four posts, and the protrusion is configured to be engaged in a mounting hole defined in the fan.

18. The mounting apparatus of claim 11, wherein each of the two securing boards further comprises four posts located on the board body, a protrusion extends from each of the four posts, and the protrusion is configured to be engaged in a mounting hole defined in the fan.
